(19) United States
(12) Patent Application Publication
(10) Pub. No.: US 2006/0225934 A1
(43) Pub. Date: Oct. 12, 2006

(54) Child's riding vehicle

(76) Inventor: Eric Fobean, Stow, OH (US)

Correspondence Address: Cynthia S. Murphy;Renner, Otto, Boisselle & Sklar, LLP, 1621 Euclid Avenue, Nineteenth Floor, Cleveland, OH, 44115, US

(21) Appl. No.: 11/102,975

(22) Filed: Apr. 11, 2005

(51) Int. Cl. B60K 1/00; B62D 25/10

(52) U.S. Cl. 180/69.21; 180/65.1

(57) ABSTRACT

A child's riding vehicle has a hood (18) comprising a hood cover (42) and a grill (44). The grill (44) is pivotally connected to a bumper (28) attached to a front wall of the vehicle body thereby pivotally connecting the hood (18) to the vehicle body. The hood (18) pivots forward to move from a closed position to an opened position and pivots rearward to move from the opened position to the closed position. The pivotal connection between the bumper (28) and the grill 44) can be such that the hood (18) will be reconnectably disconnected from the vehicle body if it is pulled past its opened position. The hood (18) has a center of gravity, when its opened position, such that gravity pulls the hood (18) away from the closed position whereby no spring biasing and/or special latches are necessary.

### FIELD OF THE INVENTION

This invention relates generally to a child's riding vehicle and, more particularly, to a riding vehicle for a child that has a hood that opens to provide access to a compartment.

### BACKGROUND OF THE INVENTION

Children enjoy mimicking adult behavior and the driving of vehicles is certainly no exception. For this reason, riding vehicles, and especially those modeled after automotive vehicles driven by adults, are appealing to children. A child's riding vehicle will typically comprise a vehicle body adapted to carry at least one child, wheels for moving the vehicle body, a motor for driving the wheels, and a battery for powering the motor. A convenient storage place for the battery is in a compartment in a front part of the vehicle body that resembles the “under-the-hood” region of an adult vehicle. When access to the battery is not required, this compartment can be covered by an openable body portion, that is a hood, resembling the analogous part in an adult vehicle.

### SUMMARY OF THE INVENTION

The present invention provides a child's riding vehicle having a hood that can be easily moved between a closed position and opened position to, for example, gain access to an “under-the-hood” compartment in the front portion of the vehicle body. The hood design does not depend upon any spring biasing or special latches to hold the hood in the opened (or closed) position and/or has a breakaway feature should the hood be “over-opened.”

More particularly, the present invention provides a child's riding vehicle comprising a vehicle body adapted to carry a child, wheels for moving the vehicle body, a battery for powering a motor that drives the wheels, and a hood that moves between an opened position and a closed position relative to the vehicle body. The hood has a center of gravity, when its opened position, such that gravity pulls the hood away from the closed position. Additionally or alternatively, the pivotal connection between the hood and vehicle body is reconnectably disconnected upon the hood being pulled past its opened position, thereby separating the hood from the vehicle body. The hood can comprise a hood cover and a grill, a bumper can be attached to a front wall of a vehicle body, and the pivotal connection can be formed between the grill and the bumper.

These and other features of the invention are fully described and particularly pointed out in the claims. The following description and annexed drawings set forth in detail a certain illustrative embodiment of the invention, this embodiment being indicative of but one of the various ways in which the principles of the invention may be employed.

### DRAWINGS

FIGS. 1A and 1B are perspective views of child's riding vehicle, the vehicle being shown in FIG. 1A with its hood in a closed position and being shown in FIG. 1B with its hood in an opened position.

FIG. 2A is a perspective view of the vehicle body.

FIG. 2B is a top plan view of the vehicle body.

FIGS. 3A and 3B are front and rear perspective views, respectively, of the bumper of the vehicle.

FIGS. 4A and 4B are top and bottom perspective views, respectively, of a cover portion of the hood.

FIGS. 5A and 5B are front and rear perspective views, respectively, of a grill portion of the hood.

FIG. 5C is a front plan view of the grill.

FIG. 5D is a sectional view of the grill as seen along line 5D-5D in FIG. 5C.

FIG. 6A a front view of the bumper and the hood, with the hood being shown in the closed position.

FIGS. 6B and 6C are side views of the bumper and the hood, with the hood being shown in the closed position and the opened position, respectively.

FIGS. 7A-7D are schematic views of an opening and a post which are used to form a pivotal connection between the bumper and the hood.

### DETAILED DESCRIPTION

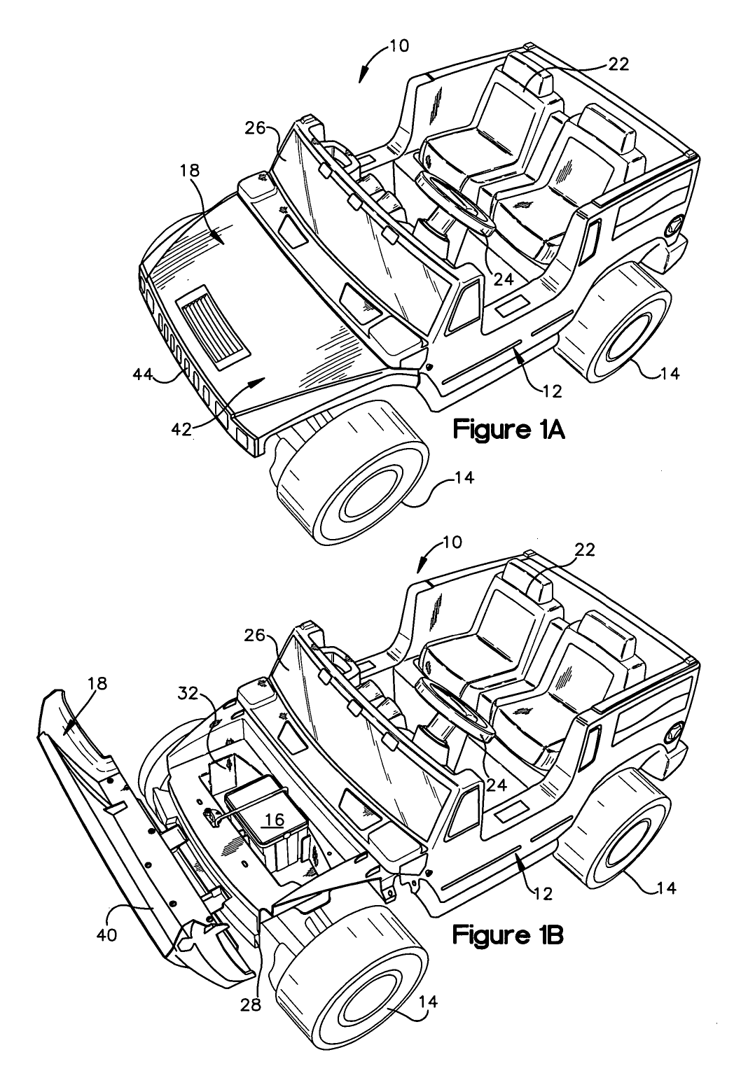

Referring now to the drawings, and initially to FIGS. 1A and 1B, a child's riding vehicle 10 according to the present invention is shown. In the illustrated embodiment, the child's riding vehicle 10 is modeled to resemble an adult-drive off-road vehicle, namely a model of the Hummer® vehicles offered by General Motors Corporation. That being said, the vehicle 10 may take on any form adapted to simulate real vehicles in a reduced scale, such as, for example, a car, truck, jeep, bus, motorcycle, carriage, tractor, construction equipment, etc.

The vehicle 10 generally comprises a vehicle body 12 adapted to carry a child, wheels 14 for moving the vehicle body 12, a motor (not specifically shown) for driving the wheels 14, a battery 16 for powering the motor, and a hood 18. The vehicle body 12 defines the overall structure of the vehicle 10 and other components, such as seats 22, a steering wheel 24, a windshield 26, and a bumper 28, are connected thereto. In the illustrated embodiment, a compartment 32 is formed in a front part of the vehicle body 12 (e.g., forward of the windshield 26) and the battery 12 is situated within this compartment 32. Also in the illustrated embodiment, the bumper 28 is secured to a front wall (namely a ledge-like wall 70, introduced below) of the vehicle body 12.

The hood 18 is pivotally connected to the vehicle body 12 and, more particularly, the hood 18 is pivotally connected to the bumper 28 which in turn is fixed to the vehicle body 12. The pivotal connection allows the hood 18 to be movable relative to the vehicle body 12 between a closed position (FIG. 1A) and an opened position (FIG. 1B). The hood 18 pivots forward (i.e., away from the windshield 26) to move from the closed position to the opened position and pivots rearward (i.e., towards the windshield 26) to move from the opened position to the closed position. In the illustrated embodiment, the hood 18 includes a main cover 42 and a grill 44 attached thereto, with the grill 44 being pivotally attached to the bumper 28 to form the pivotal connection between the vehicle body 12 and the hood 18.

When the hood 18 is in its opened position (FIG. 1B), its center of gravity is offset from a vertical line in a forward direction. Thus, when the hood 18 is in its opened position, gravity pulls it downward in a forward direction away from the closed position, rather than downward in a rear direction towards the closed position. Thus, no spring-biasing and/or special latches are required to hold the hood 18 in its opened position.

The hood 18 is designed to “break-away” from the vehicle body 12 should it be pulled “too far” forward past its opened position. This is accomplished by making the pivotal connection between hood 18 and vehicle body 12 having enough resilience to “give” and allow a disconnection should a “hood-over-opening” occur. This resilience also allows the reconnection of the pivotal connection to thereby reconnect the hood 18 to the vehicle body 12 after a break-away of the hood. It may be noted that because, in the illustrated embodiment, the pivotal connection is between the bumper 28 and the grill 44, only these components (and not the entire vehicle body 12 and/or the entire hood cover 42) need to posses the required resiliency.

In the illustrated embodiment, the hood 18 covers the compartment 32 when in the closed position and allows access to the compartment 32 when in the opened position. If, as shown, the battery 16 is stored in the compartment 32, the opened hood 18 allows an adult to access the battery 16 thereby resembling a mechanic “wording under the hood.” That being said, the compartment 32 need not be the storage location for the battery 16 and, for that matter, the “under-the-hood” region of the vehicle body 12 need not include a compartment.

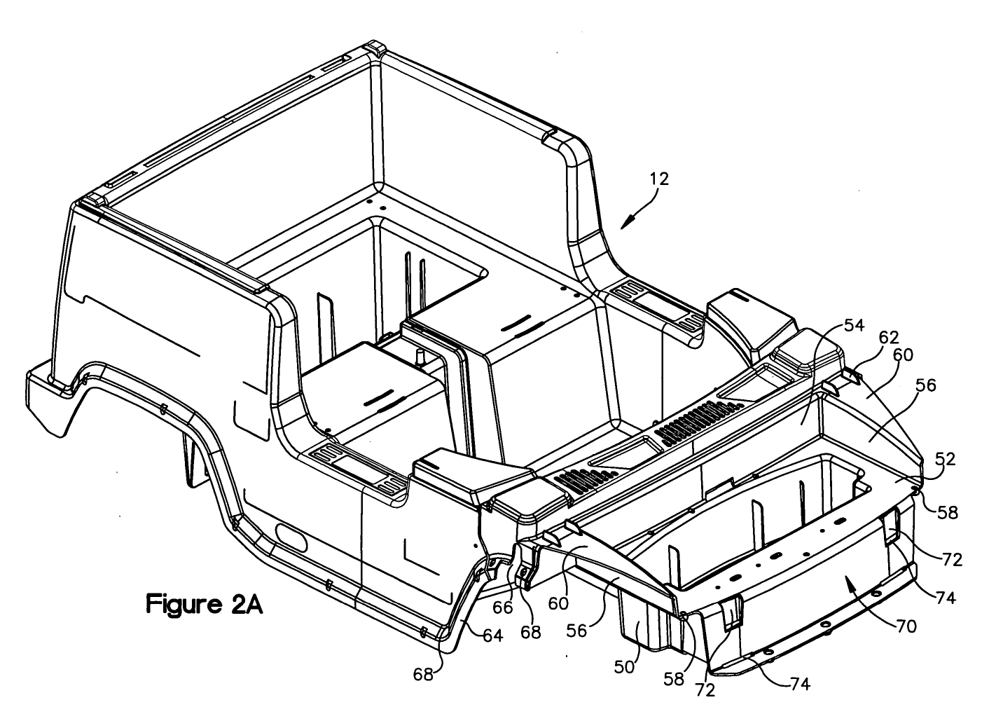

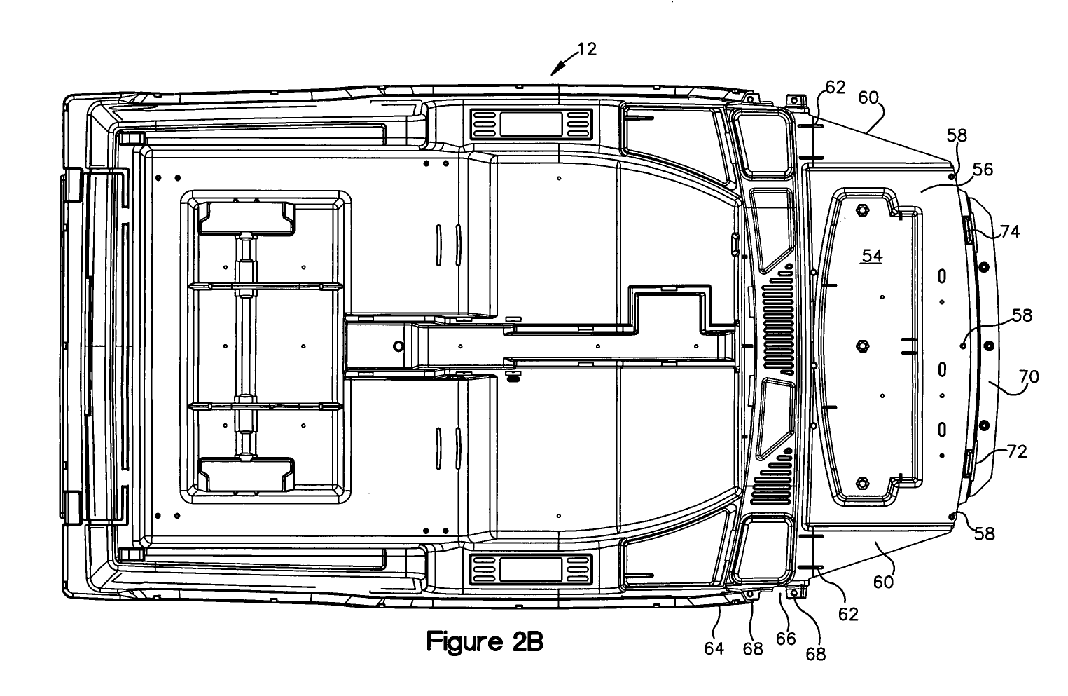

Referring now to FIGS. 2A and 2B, the vehicle body 12 is shown in detail. In its front hood-related-region, the illustrated vehicle body 12 includes a contoured bottom wall 50 defining the compartment 32, a relatively horizontal wall 52 surrounding the compartment 32, a rear wall 54, and side walls 56. The rear wall 54 and the side walls 56 extend upwardly from rear and side edges, respectively, of the compartment-surrounding wall 52. Three circular openings 58 can be provided in the front edge of the wall 52 for receipt of complement components in the hood cover 42 (namely posts 116, introduced below.)

The illustrated vehicle body 12 further comprises side shelves 60 which extend outwardly from the top edges of the side walls 56 and which taper inwardly in the forward direction. Resting ribs 62 for the hood cover 42 can project upward from rear regions of the shelves 60. A flanged rim 64 extends downward from the back outer edges of the shelves 60 and continues rearward around the vehicle body 12 after being interrupted by a notch 66. An opening 68 can be provided on the flange 64 on either side of the notch 66 for receipt of complement components in the hood cover 42 (namely posts 118, introduced below).

A curved front ledge-like wall 70 can extend downward and then outward from the front edge of the compartment-surrounding wall 52. The ledge-like wall 70 functions as a mounting platform for the bumper 28 and, to this end, can include slots 72 and slots 74 for receipt of complement components on the bumper 28 (namely tabs 94 and 96, introduced below.)

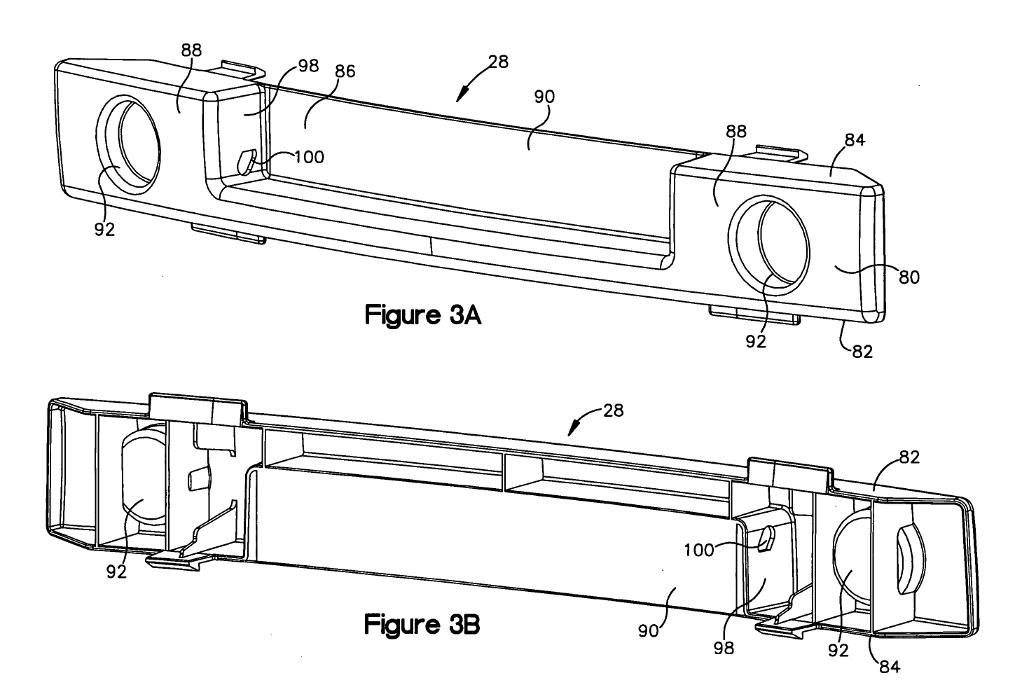

Referring now to FIGS. 3A and 3B, the bumper 28 is shown in detail. The bumper 28 has a front wall 80, a bottom wall 82, and a stepped top wall 84. The walls 80, 82, and 84 are shaped to form a roughly rectangular structure that is curved to abut against the ledge 70 and that includes a central rectangular recess 86 surrounding by two rectangular blocks 88. A back wall 90 closes the back of the recess 86, with the rest of the back of the bumper 28 being left open.

The 88 can each include a circular indentation 92 for insertion of indicia corresponding to vehicle headlights. Connection tabs 94 extend rearward from the back edge of the top wall 84 and connection tabs 96 extend downward from the rear edge of the bottom 82 for mating with the slots 72 and 74, respectively, in the ledge 70. In the non-recess areas of the bumper 28, various ribs or other reinforcing or strengthening members can project rearward from the front wall 80 and/or can project up/down from the bottom wall 82 and top wall 84.

The top wall 84 has vertical sections 96 forming the sides of the recess 86 and an opening 100 is formed near the bottom of each of the sections 96. These openings 100 coordinate with components of the grill 44 (namely posts 150, introduced below) to form the pivotal connection between the hood 18 and the vehicle body 12. In the illustrated embodiment, the openings 100 each have an oval shape which is slanted upward in the rear direction and which has a cut-off upper end. The area within the blocks 88 adjacent the openings 100 is open and/or hollow, thereby allowing at least these regions of the bumper 28 to be somewhat resilient.

Referring now to FIGS. 4A and 4B, the hood cover 42 is shown in detail. The hood cover 42 comprises a top wall 110, side walls 112, and a front wall 114. Posts 116 extend downward from the top wall 110 for resting within the openings 58 near the front edge of the compartment-surrounding wall 52 of the vehicle body 12. Posts 118 extend downward from the side walls 112 for insertion into the openings 68 in the flanged rim 64 of the vehicle frame. Although not shown in these drawings, the hood cover 42 can also include separate side panels secured to the side walls 112 and openings 120 can be provided for this purpose. Openings 122 are provided in the front wall 114 for the fasteners (not shown) used to secure the grill 44 to the hood cover 42.

Ribs (shown but not specifically numbered) can be provided for supporting the posts 116 and/or for strengthening the area surrounding the openings 120 and 122.

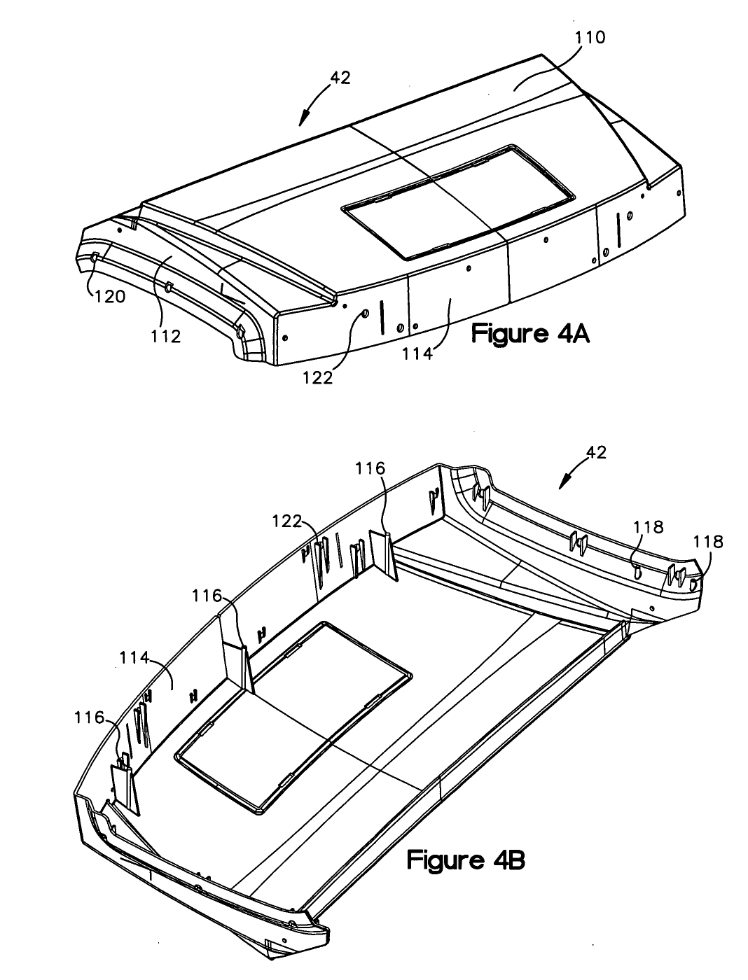

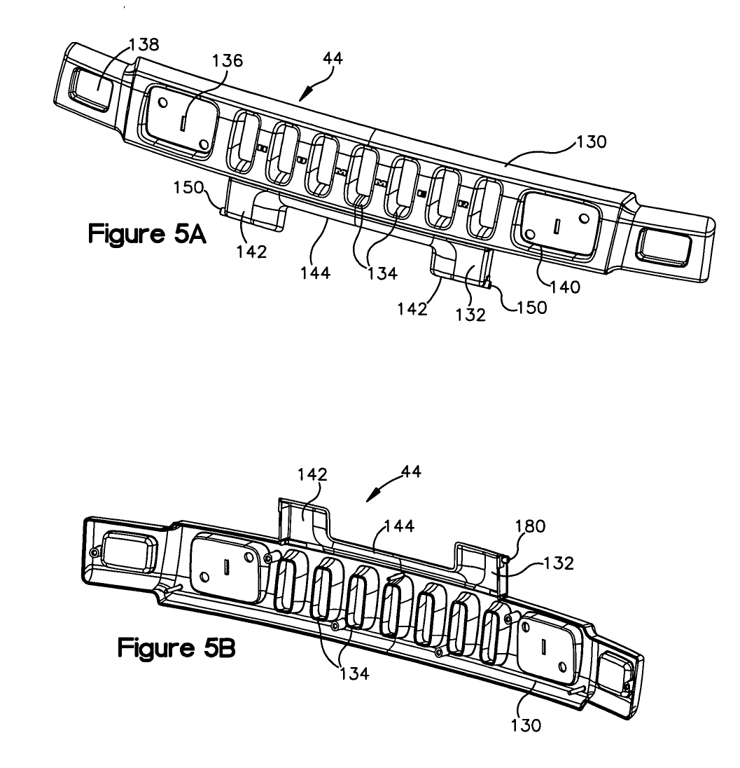

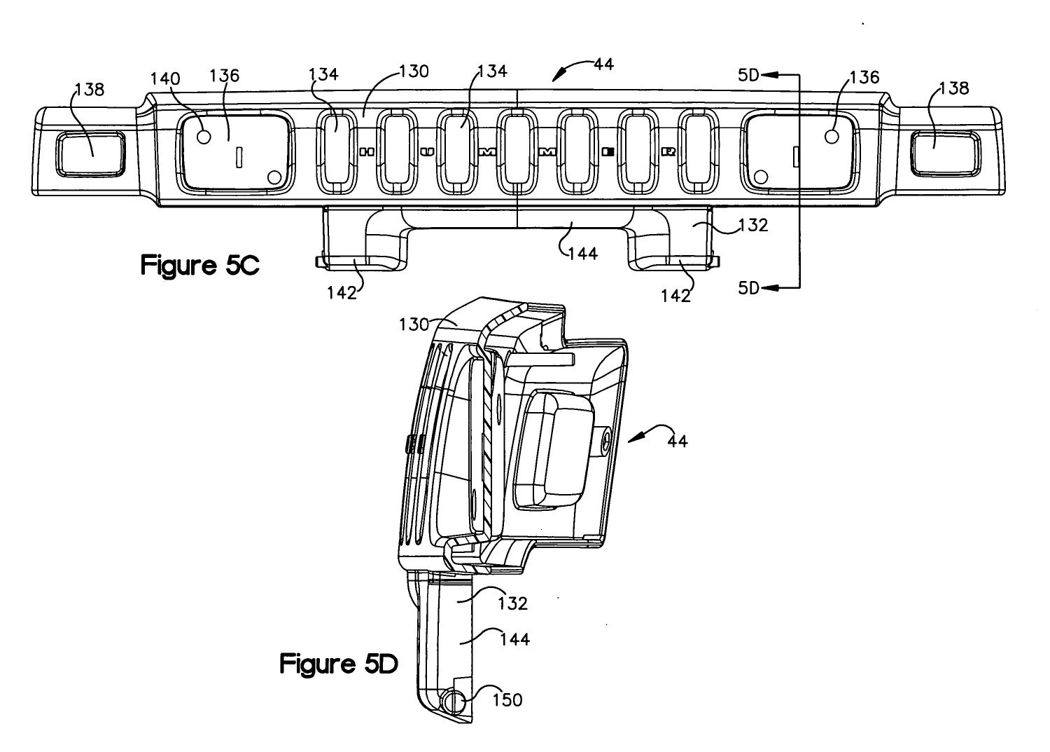

Referring now to FIGS. 5A-5D, the hood grill 44 is shown in detail. The hood grill 44 comprises an upper strip 130 and a projection 132 extending downward from the bottom edge of the strip 30. The strip 130 has a rectangular shape and is constructed to resemble a grill on an actual automotive vehicle. To this end, the strip 30 can include grid openings 134 and/or indentations 136/138 into which indicia resembling headlights, flashers, or blinkers can be inserted. The upper section 130 also includes openings 118 for securing the grill 44 to the cover 42 with suitable fasteners (not shown).

The lower projection 132 is sized to fit within the recess 86 in the bumper 28 and, in the illustrated embodiments, includes two almost-square end sections 142 and a thin rectangular connecting section 144. Pivot posts 150 extend outward from the side edges of the sections 142 and are positioned for insertion into the openings 100 in the wall sections 98 defining the sides of the recess 86. As was indicated above, the area within the blocks 88 adjacent the openings 100 is open and/or hollow, thereby allowing insertion of the posts 150 therethrough.

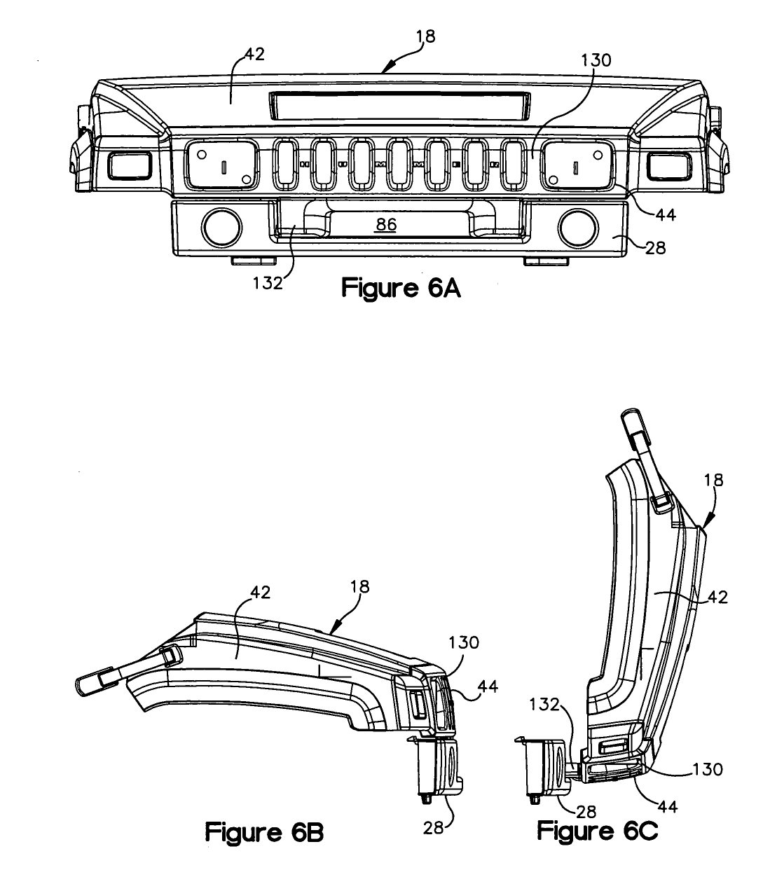

In FIGS. 6A-6C, the pivotal relationship between the hood 18 and the bumper 28 is shown. As was alluded to and/or explained above, the bumper 28 is fixedly attached to the vehicle body 12, the hood grill 44 is fixedly attached to the hood cover 42, and the bumper 28 and the hood grill 44 are pivotally connected via the openings 100 and the posts 150. When the hood 18 is in its closed position (FIGS. 6A and 6B), the grill 44 is vertically oriented and its projection 132 is positioned with the recess 86 of the bumper. In this closed position, the strip section 130 and the projection 132 extending upward from the pivot axis formed by the posts 150 (the posts are not really visible in FIGS. 6A-6C). The grill 44 is thereby located above the bumper 28 and at the front of the hood cover 42. Upon movement of the hood 18 to its opened position (FIG. 6C), the grill 44 is horizontally oriented with its projection 132 extending forward from the pivot axis formed by the posts 150. As was mentioned above, this positioning of the hood 18 preferably places its center-of-gravity so that the gravitational force pulls the hood away from, rather than towards, its opened position.

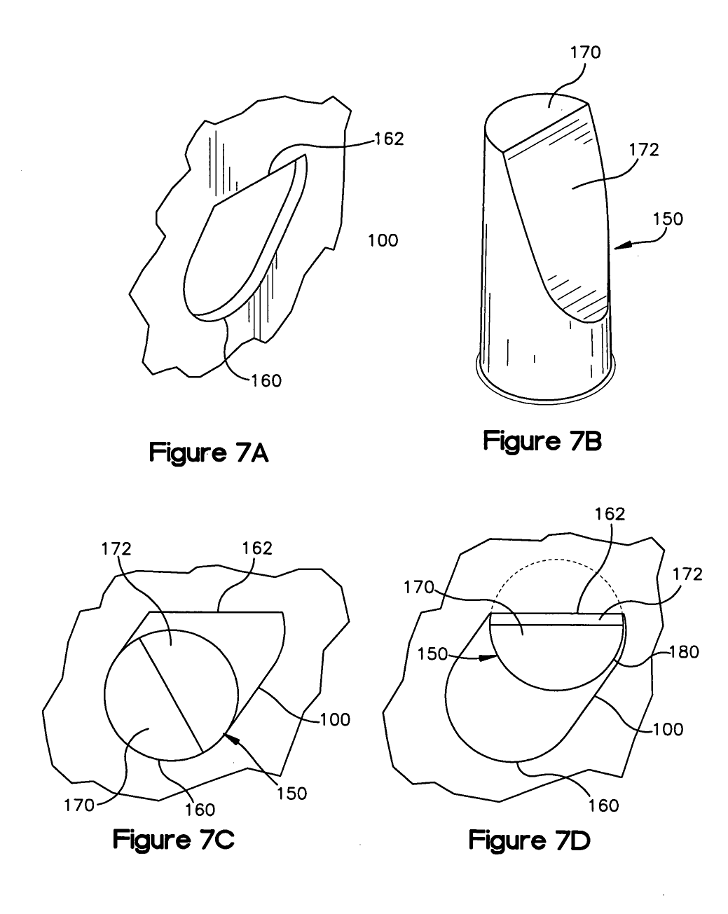

The openings 100 and the pivot posts 150 are sized and shape to sufficiently secure the hood 18 to the vehicle body 12 during normal use, to allow pivoting of the hood 18 between the closed position and the opened position, and to allow the hood 18 to separate from the vehicle body 12 should the hood 18 be forced past its fully opened position. As shown more clearly in FIG. 7A, in the illustrated embodiment, the openings 100 each have a slanted cut-off oval shape with round bottom edge 160 and a flat upper edge 162. As shown more clearly in FIG. 7B, the pivots posts 150 each have a “half-cambered” cylindrical shape with a semi-cylindrical side 170 and a sloped (towards the distal end) side 172.

When the hood 18 is the closed position, the cylindrical (non-sloped) side 170 of the pivot post 150 rests in the bottom circular edge of the opening 100. (See FIG. 7C.) When the hood 18 is the open position, the sloped side 172 of the post 150 rests against the flat upper edge 162 of the opening 100. In this manner, if the hood 18 is pulled past its opened position, the resiliency of the bumper 28 and/or grill 44 will allow the sloped side 172 side of the post 150 to slide outwardly on the flat edge 162 of opening 100 for release of the grill 44 (and thus the hood 18) from the bumper 28 (and thus the vehicle body 12). After this break-away of the hood 18, it can be reconnected to the bumper 28 in a similar manner. In other words, the hood 18 is reconnectably disconnected from the vehicle body 12 should a “hood-over-opening” occur.

Although the invention has been shown and described with respect to certain preferred embodiments, it is evident that equivalent and obvious alterations and modifications will occur to others skilled in the art upon the reading and understanding of this specification.

1. A child's riding vehicle comprising:
a vehicle body adapted to carry a child,
wheels for moving the vehicle body,
a battery for powering a motor that drives the wheels, and
a hood that moves between an opened position and a closed position relative to the vehicle body;
wherein the hood has a center of gravity, when its opened position, such that gravity pulls the hood away from the closed position.

2. A child's riding vehicle as set forth in claim 1, wherein the hood is pivotally connected to a front wall of the vehicle body and pivots forward to move from the closed position to the opened position and pivots rearward to move from the opened position to the closed position.

3. A child's riding vehicle as set forth in claim 2, wherein the pivotal connection between the hood and vehicle body is disconnected upon the hood being pulled past its opened position, thereby separating the hood from the vehicle body, and wherein the hood can be rejoined to the vehicle body by reconnecting the pivotal connection.

4. A child's riding vehicle as set forth in claim 3, wherein the pivotal connection comprises posts pivotally positioned within openings and wherein the posts are withdrawn from the openings upon the hood being pulled past its opened position thereby separating the hood from the vehicle body.

5. A child's riding vehicle as set forth in claim 2, wherein the pivotal connection comprises posts pivotally positioned within openings, wherein the posts extend from a projection, and wherein the openings are positioned in wall sections defining a recess.

6. A child's riding vehicle as set forth in claim 1, wherein the hood includes a cover and a grill fixed to a front wall of the cover, wherein the vehicle body includes a front wall and a bumper fixed to the front wall, and wherein the grill is pivotally connected to the bumper.

7. A child's riding vehicle as set forth in claim 1, wherein the vehicle body includes a compartment which is covered when the hood is in the closed position and which is accessible when the hood is in the opened position.

8. A child's riding vehicle as set forth in claim 7, wherein the battery is positioned within the compartment.

9. A child's riding vehicle comprising:
a vehicle body adapted to carry a child,
wheels for moving the vehicle body,
a battery for powering a motor that drives the wheels,
a hood that moves between an opened position and a closed position relative to the vehicle body;
a pivotal connection between the hood and the vehicle body that is reconnectably disconnected upon the hood being pulled past its opened position.

10. A child's riding vehicle as set forth in claim 9, wherein the hood is pivotally connected to a front of the vehicle body and pivots forward to move from the closed position to the opened position and pivots rearward to move from the opened position to the closed position.

11. A child's riding vehicle as set forth in claim 9, wherein the pivotal connection comprises posts pivotally positioned within openings and wherein the posts are withdrawn from the openings upon the hood being pulled past its opened position thereby separating the hood from the vehicle body.

12. A child's riding vehicle as set forth in claim 11, wherein the posts extend from a projection, and wherein the openings are positioned in wall sections defining a recess.

13. A child's riding vehicle as set forth in claim 9, wherein the hood includes a cover and a grill fixed to a front wall of the cover, wherein the vehicle body includes a front wall and a bumper fixed to the front wall, and wherein the grill is pivotally connected to the bumper.

14. A child's riding vehicle comprising:
a vehicle body adapted to carry a child;
wheels for moving the vehicle body;
a battery for powering a motor that drives the wheels;
a bumper attached to a front wall of the vehicle body;
a hood including a hood cover and a grill attached to the hood cover, and
a pivotal connection between the bumper and the grill that allows the hood to move relative to the vehicle body between a closed position and an opened position.

15. A child's riding vehicle as set forth in claim 14, wherein the hood pivots forward to move from the closed position to the opened position and pivots rearward to move from the opened position to the closed position.

16. A child's riding vehicle as set forth in claim 2, wherein the pivotal connection comprises posts pivotally positioned within openings, wherein the posts extend from a projection of the grill, and wherein the openings are positioned in wall sections defining a recess in the bumper.

17. A child's riding vehicle comprising a vehicle body adapted to carry a child, wheels for moving the vehicle body, a battery for powering a motor that drives the wheels, a bumper attached to a front wall of the vehicle body, a hood including a hood cover and a grill attached to the hood cover, and a pivotal connection between the bumper and the grill to move the hood relative to the vehicle body between a closed position and an opened position;
wherein the hood pivots forward to move from the closed position to the opened position and pivots rearward to move from the opened position to the closed position;
wherein the hood has a center of gravity, when in its opened position, such that gravity pulls the hood away from the closed position; and
wherein the pivotal connection is reconnectably disconnected upon the hood being pulled past its opened position thereby separating the hood from the vehicle body.

18. A child's riding vehicle as set forth in claim 17, wherein the pivotal connection comprises posts pivotally positioned within openings and wherein the posts are withdrawn from the openings upon the hood being pulled past its opened position thereby separating the hood from the vehicle body.

19. A child's riding vehicle as set forth in claim 18. wherein the vehicle body has a compartment that is covered when the hood is in the closed position and accessible when the hood is in the closed position.

20. A child's riding vehicle as set forth in claim 19, wherein the battery is situated within the compartment.
